(19) United States
(12) Patent Application Publication
(10) Pub. No.: US 2010/0196256 A1
(43) Pub. Date: Aug. 5, 2010

(54) TITANIA NANOSHEETS DERIVED FROM ANATASE DELAMINATION

(75) Inventors: Yue Wu, Chapel Hill, NC (US); Gregory Mogilevsky, Chapel Hill, NC (US)

Correspondence Address: MOORE & VAN ALLEN PLLC, P.O. BOX 13706, Research Triangle Park, NC, 27709, US

(73) Assignee: THE UNIVERSITY OF NORTH CAROLINA AT CHAPEL HILL, Chapel Hill, NC (US)

(21) Appl. No.: 12/669,378

(22) PCT Filed: Jul. 15, 2008
(86) PCT No.: PCT/US08/70083

§ 371 Date: Mar. 10, 2010

Related U.S. Application Data
(60) Provisional application No. 60/950,238, filed on Jul. 17, 2007.

(51) Int. Cl. B24B 1/00; C01G 23/047

(52) U.S. Cl. 423/610; 451/36

(57) ABSTRACT

A novel titania nanosheet material synthesized using a novel mechanism using titania nanotubes as a starting material is described. The novel nanosheet material may be useful for many coating applications where titania nanoparticles are traditionally deposited including, but not limited to, self-cleaning coatings, gas sensors, hydrogen production, photocatalytic solar cells, and batteries.

### GOVERNMENT RIGHTS

The United States Government has rights pursuant to the Army Research Office and National Science Foundation grant numbers DAAD19-03-1-0326 and DMR-0513915.

### FIELD

The present invention relates generally to novel titania nanosheet material synthesized using a novel mechanism. The titania nanosheets expose only one orientation due to their geometry, said orientation enhancing the efficiency of desired chemical processes. Furthermore, the nanosheet has adhesion properties that are superior to those of titania nanoparticles known in the art.

### DESCRIPTION OF THE RELATED ART

Titania (titanium dioxide) is commonly presented as a three-dimensional structure material (3D) and is used as a semiconductor material in the construction of electronic and optoelectronic devices, in the manufacturing of pigments and coatings, as a catalyst and/or catalyst support in several processes, as a photocatalyst in the degradation of organic compounds during environmental protection processes and in the production of hydrogen by water decomposition, as photosensitive material in the construction of fuel cells and solar cells, etc. In addition, titania has been used for secondary batteries such as lithium batteries, hydrogen occlusion materials, proton conductive materials, etc.

Titania is known to most commonly exist in three crystalline phases, anatase (see FIG. 1a), rutile and brookite, as well as a less common B-phase and amorphous structure. The anatase and rutile phases have different tetragonal crystal lattices, and the brookite phase has an orthorhombic crystal lattice or structure. Each phase presents different properties and anatase was found to exhibit efficiency superior to that of rutile in various applications such as catalysis and solar cells.

Over the past decade, significant progress has been made in discovering new forms of nanostructured titania including titania nanotubes as discovered by Kasuga et al. in 1998 (Kasuga, T., et al., Langmuir, 1998, 14, 3160-3163). Despite the many interesting properties of titania nanotubes that have been reported, there is no established structure model for the nanotubes. FIG. 2 is a transmission electron microscope (TEM) image showing the general morphology of the synthesized nanotubes. The tubular wall consists of a layered structure with layer spacing of about 8.0 Å. Often, the number of layers on one side is one more than the other side of the wall, as expected from a scroll structure, and as such, the nanotubes are often called nanoscrolls.

Materials based on layered structures have particularly unique properties such as high T_{c}-superconductivity and important applications such as graphite anode Li-ion batteries. Although there are reports of layered titania in the art, no one has reported a simple, low cost, high quantity process for producing anatase-like nanosheet material. Accordingly, it would be a significant advance in the art to produce anatase-based titania nanosheet structures in bulk quantities.

The present inventors have surprisingly discovered that anatase titania possesses characteristics of a layered structure with potential for delamination along the [001] direction. The delaminated anatase nanosheets described herein can be produced in bulk quantities starting with titania nanotube reactants. The novel nanosheet material may be useful for many applications where titania nanoparticles are traditionally employed.

### SUMMARY

The present invention relates generally to novel titania nanosheets and a process of making said titania nanosheets using titania nanotubes and water under neutral pH conditions. The titania nanosheets have potential for use in many applications including, but not limited to, solar cells, self-cleaning coatings, hydrogen production, gas sensing, decontamination, and batteries.

In one aspect, a method of producing titania nanosheet material is described, said method comprising grinding a titania nanoparticle slurry under grinding conditions to produce titania nanosheet material in a mixture, wherein the slurry includes titania nanoparticles and water.

In another aspect, a method of producing titania nanosheets is described, said method comprising:

grinding a titania nanotube slurry to produce titania nanosheets in a mixture, wherein the slurry includes titania nanotubes and water; and separating a titania nanosheet suspension from the mixture.

Still another aspect relates to a titania nanosheet, wherein the titania nanosheet material has about a 4.0 eV band gap.

Yet another aspect relates to a titania nanosheet, wherein the titania nanosheet material has a ¹H NMR MAS spectra peak at about 4.6 ppm for nanosheet samples desiccated for 1 day.

Another aspect relates to a titania nanosheet, wherein the titania nanosheet material has a ¹H NMR MAS spectra peak at about 1.2 ppm for nanosheet samples desiccated for 1 day.

In yet another aspect, an article of manufacture comprising a substrate and at least one layer of titania nanosheet material is described, wherein the titania nanosheet material comprises a property selected from the group consisting of:
(a) about a 4.0 eV band gap;
(b) a ¹H NMR MAS spectra peak at about 4.6 ppm for nanosheet samples desiccated for 1 day;
(c) a ¹H NMR MAS spectra peak at about 1.2 ppm for nanosheet samples desiccated for 1 day; and
(d) combinations thereof.

In still another aspect, a method of manufacturing an article of manufacture is described, said method comprising:
depositing at least one titania nanosheet on a substrate, wherein the titania nanosheet material comprises a property selected from the group consisting of:
(a) about a 4.0 eV band gap;
(b) a ¹H NMR MAS spectra peak at about 4.6 ppm for nanosheet samples desiccated for 1 day;
(c) a ¹H NMR MAS spectra peak at about 1.2 ppm for nanosheet samples desiccated for 1 day; and
(d) combinations thereof.

Other aspects, features and embodiments will be more fully apparent from the ensuing disclosure and appended claims.

### BRIEF DESCRIPTION OF THE DRAWINGS

FIG. 1: (a) Anatase unit cell. The apical bond length is 1.98 Å and the equatorial bond length is 1.94 Å. The box in the unit cell shows where the unit cell is cleaved to achieve delamination. (b) Illustration of layers delaminated in [001] direction. (c) and (d) Delaminated structure viewed from different perspectives. The glide shift is 78° at interlayer spacing of 8.7 Å. The three major planes, (002), (101), and (103) that are seen in XRD are labeled.

FIG. 2: TEM image of titania nanotubes showing interlayer spacing of 8.0 Å.

FIG. 3: XRD patterns of anatase, nanotubes, and simulation based on the delaminated anatase model shown in FIG. 1. The experiments were done with a monochromatized Cu K_{α} radiation (λ=0.15405 nm).

FIG. 4: TEM (a) and HRTEM (b) images of nanosheets, and SAED (c) of the high-resolution image.

FIG. 5: ¹H NMR of nanosheets and nanotubes. The shift reference is TMS and the MAS spinning rate is 20 kHz.

FIG. 6: UV-Vis absorption spectra of anatase, nanosheets, and nanotubes.

FIG. 7: TGA spectra of nanosheets and nanotubes.

### DETAILED DESCRIPTION, AND PREFERRED EMBODIMENTS THEREOF

The present invention relates generally to novel delaminated anatase-like nanosheet structures synthesized using a novel method and to the anatase-like nanosheet structures produced thereof. Based on the electronic and optical properties, the delaminated anatase-like nanosheet structures have utility as self-cleaning coatings, gas sensors, photocatalytic solar cells, and batteries.

As defined herein, “anatase” corresponds to a tetragonal 4/m 2/m 2/m titanium dioxide structure and is often referred to as octahedrite or ditetragonal dipyramidal. The structure is based on octahedrons of titanium oxide which share four edges and hence a four fold axis. Crystals of anatase are eight faced tetragonal dipyramids that come to sharp elongated points. Anatase is optically negative.

As defined herein, “delaminated anatase-like” corresponds to a simplified description of the structure of the novel titania nanosheets described herein. It is to be appreciated that the phrase “delaminated anatase-like” does not imply a direct physical delamination process in producing the titania nanosheets using the novel method described herein. In other words, the phrase “delaminated anatase-like” describes nothing more than the structure of the final product.

As defined herein, “not substantially cut” or “substantially uncut” corresponds to nanotubes that were subjected to the grinding process described herein, however, the average length of the nanotubes is substantially longer than 50 nm.

As defined herein, “titania nanoparticles” include, but are not limited to, nanotubes, nanoscrolls, nanofibers, nanowires, nanorods, layered titanate, anatase, and combinations thereof. For simplicity, “nanotubes” or “nanoscrolls” may be used interchangeably.

As defined herein, titania “nanosheets” corresponds to titania and hydrated titania material having about a 4.0 eV bandgap. ¹H NMR MAS spectra peaks of the titania nanosheets are positioned at (a) about 4.6 ppm and (b) about 1.2 ppm for nanosheet samples desiccated for 1 day.

As defined herein, “desiccated” corresponds to a material having low moisture, preferably less than about 25 wt % water, more preferably less than about 10 wt % water, even more preferably less than about 5 wt % water, and most preferably less than about 1 wt % water, based on the total weight of the composition.

Delaminated anatase-like nanosheet material may be synthesized by grinding a bulk amount of titania nanotubes, in a grinding vessel in the presence water. Grinding means contemplated include, but are not limited to, ball milling, rod milling, autogeneous milling, colloid milling, disc milling, high pressure grinding rolls, and equivalent thereof. Preferably, the grinding is carried out using a ball mill. Grinding media such as beads may be added to the vessel to assist with the grinding process. The grinding media may be symmetrical or non-symmetrical, spherical, polygonal, or non-geometric in shape, are preferably hydrophobic in nature, and are preferably approximately 1±0.5 microns in mean diameter. For example, ZrO grinding media are particularly useful, although other grinding media are contemplated such as calcia stabilized zirconia, magnesia stabilized zirconia, yttria stabilized zirconia, etc. The titania nanotube reactant material may be synthesized using the hydrothermal synthesis process described by Kasuga et al. (Id., U.S. Pat. No. 6,027,775), however, the process of preparing such nanotube reactants is not limited to same. The titania nanotube reactant material may be synthesized from commercially purchased anatase nanocrystals, for example from Aldrich or Alfa Aesar. The time of grinding is dependent on the amount of water available to solubilize the nanosheets, i.e., saturation concerns. The temperature of grinding is preferably elevated, more preferably in a range from about 60° C. to about 200° C., even more preferably in a range from about 80° C. to about 120° C., and most preferably about in a range from about 90° C. to about 110° C. The mechanical grinding shortens the nanotubes to about 75 nm while the elevated temperature ensures a more efficient transformation of the shortened nanotubes into nanosheets in bulk quantities.

At the conclusion of the grinding process, the hydrophobic grinding media settle to the bottom of the vessel. The remaining solution represents a suspension of at least three intermixed titania species which may be separated into layers according to density using sonication and centrifugation. In the process of cutting the long synthesized nanotubes with grinding in solution, the present inventors surprisingly discovered that the shortened nanotubes transform efficiently into nanosheets in bulk quantity. The most dense bottom layer includes nanotubes that were not substantially cut by the grinding process. The middle layer consists of cut nanotubes that were shortened by the grinding process. The least dense top layer consists of the nanosheets described herein dispersed in water. Unlike titania nanotubes, such nanosheets form a colloidal suspension in water and would not precipitate even under centrifugation. The three layers may be easily separated from one another using processes known in the separation arts. Importantly, the cut nanotubes of the middle layer may be useful for applications such as the storage of small ligands and drug delivery systems.

The nanosheet material described herein may be produced in bulk quantities directly from titania nanotubes under neutral pH conditions without the use of environmentally hazardous solvents. In other words, the novel method described herein is easier to perform, more cost effective and more environmentally friendly than other titania-producing methods known in the art. As defined herein, “neutral pH” conditions correspond to pH in a range from about 5 to about 9, preferably about 6 to about 8.

Accordingly, in one aspect, a method of producing titania nanosheets is described, said method comprising grinding a titania nanotube slurry to produce titania nanosheets. The grinding is effectuated for a sufficient amount of time to convert at least a portion of nanotubes to nanosheets.

In another aspect, a method of producing titania nanosheets is described, said method comprising grinding a titania nanotube slurry to produce titania nanosheets in a mixture, wherein the slurry comprises, consists of, or consists essentially of titania nanoparticles and water. The grinding is effectuated for a sufficient amount of time to convert at least a portion of nanotubes to nanosheets. Preferably, the titania nanoparticles include titania nanoscrolls and as such, the mixture may include titania nanosheets, partially cut titania nanoscrolls, and substantially uncut titania nanoscrolls. It should be appreciated that the slurry may further include grinding media.

In another aspect, a method of producing titania nanosheets is described, said method comprising:
grinding a titania nanotube slurry to produce titania nanosheets in a mixture, wherein the slurry comprises, consists of, or consists essentially of titania nanotubes and water; and
separating a titania nanosheet suspension from the mixture.
   The mixture subsequent to the onset of grinding at an elevated temperature comprises titania nanosheets, partially cut titania nanotubes, and substantially uncut titania nanotubes. The grinding is effectuated for a sufficient amount of time to convert at least a portion of the nanoscroll material to nanosheets. Preferably, the grinding is effectuated using a ball mill. It should be appreciated that the slurry may further include grinding media.

In still another aspect, prior to or upon saturation of the top layer of water with titania nanosheets, the top layer may be removed, e.g., by siphoning, etc., and additional fresh water may be added and the grinding process may be continued. In other words, the production of titania nanosheets is dependent on the saturation of the top layer of solution with titania nanosheets. Following the addition of fresh water, the partially cut titania nanotubes, substantially uncut titania nanotubes, and/or newly added nanotube material, may be ground to produce titania nanosheets.

The delaminated anatase (along the [001] direction) model describes the surface chemistry of the nanosheets very well but the XRD of said model provides the structural basis for the precursor nanotubes (see FIG. 3).

Yet another aspect relates to an article of manufacture comprising a substrate and at least one layer of titania nanosheet material, wherein the titania nanosheet material comprises a property selected from the group consisting of: about a 4.0 eV band gap; a ¹H NMR MAS spectra peak at about 4.6 ppm for nanosheet samples desiccated for 1 day; a ¹H NMR MAS spectra peak at about 1.2 ppm for nanosheet samples desiccated for 1 day; and combinations thereof. Substrates include quartz, glass, polymeric surfaces, and various metal surfaces.

Still another aspect relates to a method of manufacturing an article of manufacture, said method comprising:
depositing at least one titania nanosheet material on a substrate, wherein the nanosheet material comprises a property selected from the group consisting of: about a 4.0 eV band gap; a ¹H NMR MAS spectra peak at about 4.6 ppm for nanosheet samples desiccated for 1 day; a ¹H NMR MAS spectra peak at about 1.2 ppm for nanosheet samples desiccated for 1 day; and combinations thereof.
   Substrates include quartz, glass, polymeric surfaces, and various metal surfaces.

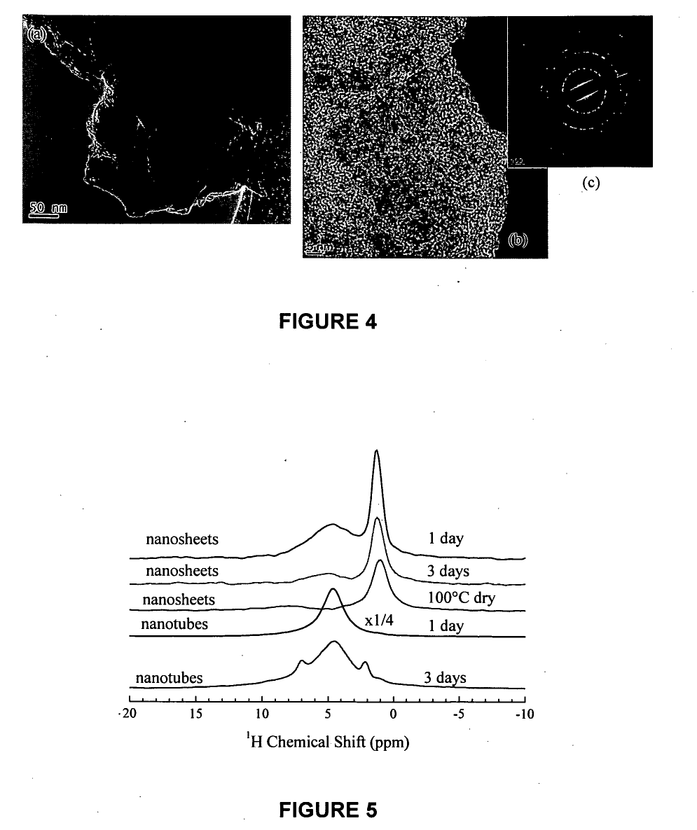

TEM images reveal that the morphology of the nanosheet material is two dimensional (see, FIG. 4(a)) and that no nanotubes coexisted in the top layer with the nanosheets. The nanosheets exhibit two-dimensional properties whether suspended in solution or coalesced in a solid state. In the solid state, the nanosheets form small islands, wherein each nanosheet is approximately 75 nm in diameter. Importantly, the nanosheets are transparent, which evidences how thin they are. Using high resolution TEM (HRTEM) (FIG. 4(b)), it was determined that the lattice fringes correspond to anatase (001) surface. Selected area electron diffraction (SAED) (FIG. 4(c)) reveals the crystalline nature of the nanosheet material.

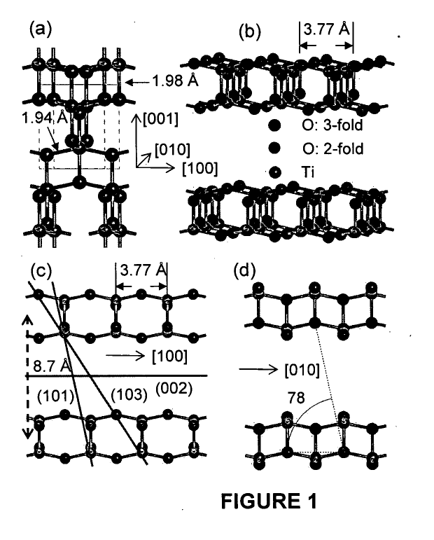

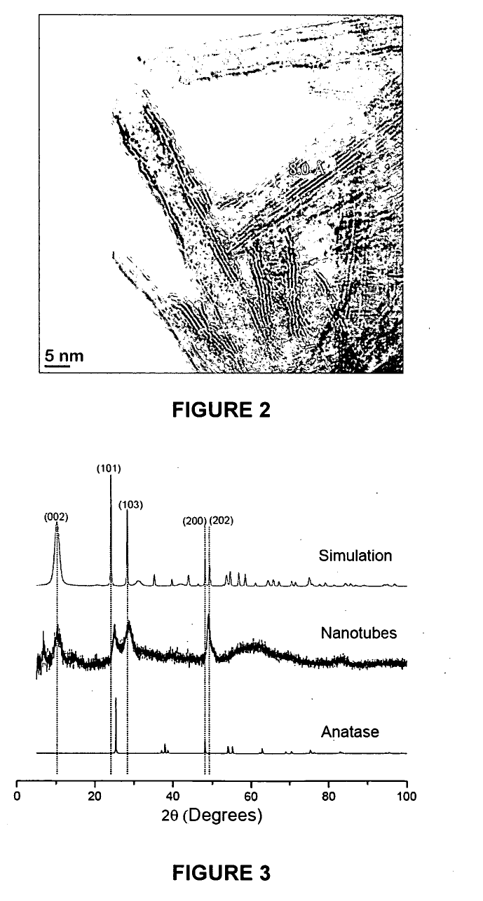

Although not wishing to be bound by theory, it is proposed that because the apical bond length of anatase is 1.98 Å and the equatorial bond length is approximately 1.94 Å, delamination may occur along the [001] direction (see, FIG. 1). Accordingly, the layers can be viewed as lying in the (001) plane and stack in the [001] direction following a glide symmetry. Such layered nanosheet structure is most likely unstable and would collapse back to anatase, however, ¹H nuclear magnetic resonance (NMR) magic angle spinning (MAS) results suggests that the structure could be stabilized by dissociation of water molecules. Dissociative adsorption of water could occur in several different schemes. For instance, dissociative adsorption of H₂O could proceed by breaking Ti—O_{bridging} bonds, forming two terminal Ti—OH hydroxyls. A mixture of dissociative and nondissociative adsorptions occurs at higher coverage. A somewhat different scheme of dissociative H₂O adsorption is not accompanied by Ti—O_{bridging} bond breaking. The OH group simply attaches to a Ti_{5c} site making it sixfold coordinated and H binds to adjacent bridging oxygen forming a terminal hydroxyl and a bridging oxygen hydroxyl.

The nanosheets readily form films on many surfaces, preferably hydrophobic surfaces, such as quartz or glass, polymeric surfaces, and various metal surfaces. It should be appreciated that the hydrophobic surface is not limited to quartz, glass, polymeric surfaces or metal surfaces—these are merely representative of some materials that may support the solid nanosheet material described herein. Methods of application include pouring or spraying the suspension including the nanosheets onto the substrate surface and evaporating the water using drying processes such as nitrogen gas, isopropanol, SEZ (spin process technology), or increased temperature to drive the water off. Alternatively, a hydrophobic surface may be immersed in the suspension, similar to the application of a Langmuir-Blodgett film, whereby the suspension is applied to the surface of the hydrophobic material, or application may be effectuated using electrophoresis. The immersion process may be repeated any number of times until the desired thickness of nanosheets is achieved on the hydrophobic surface. Once the desired thickness has been achieved, the nanosheets must be dried out using the aforementioned techniques. The applied nanosheets have negligible voids and high surface adhesion. In another alternative, following drying, the applied nanosheets may be “scraped” off the substrate to form a nanosheet powder for applications such as catalysis.

In yet another aspect, a method of producing titania nanosheets is described, said method comprising:
grinding a titania nanotube slurry to produce titania nanosheets in a mixture, wherein the slurry comprises, consists of, or consists essentially of titania nanotubes and water;
separating a titania nanosheet suspension from the mixture; and
drying the titania nanosheet suspension to obtain titania nanosheets.
   The mixture subsequent to the onset of grinding at an elevated temperature comprises titania nanosheets, partially cut titania nanotubes, and substantially uncut titania nanotubes. The grinding is effectuated for a sufficient amount of time to convert at least a portion of the nanoscroll material to nanosheets. Preferably, the grinding is effectuated using a ball mill. The drying process may include using nitrogen gas, an isopropanol dry, spin process technology, or increased temperature to drive off the water. It should be appreciated that the slurry may further include grinding media.

In still another aspect, a method of producing titania nanosheets is described, said method comprising:
grinding a titania nanoscroll slurry to produce titania nanosheets in a mixture, wherein the slurry comprises, consists of, or consists essentially of titania nanotubes and water; sonicating and centrifuging the mixture to separate the mixture into more than one layer;
separating a titania nanosheet suspension from the mixture; and
drying the titania nanosheet suspension to obtain titania nanosheets.
   The mixture subsequent to the onset of grinding at an elevated temperature comprises titania nanosheets, partially cut titania nanotubes, and substantially uncut titania nanotubes. The grinding is effectuated for a sufficient amount of time to convert at least a portion of the nanoscroll material to nanosheets. Preferably, the grinding is effectuated using a ball mill. The drying process may include using nitrogen gas, an isopropanol dry, spin process technology, or increased temperature to drive off the water. In one embodiment, at least three layers (not including any grinding media) are formed during the sonicating and centrifuging process. It should be appreciated that the slurry may further include grinding media.

Still another aspect relates to a method of manufacturing an article of manufacture, said method comprising:
depositing at least one titania nanosheet on a substrate, wherein the method of producing the nanosheet material comprises:
   grinding a titania nanoscroll slurry to produce titania nanosheets in a mixture, wherein the slurry comprises, consists of, or consists essentially of titania nanotubes and water;
   separating a titania nanosheet suspension from the mixture; and
   drying the titania nanosheet suspension to obtain titania nanosheets.
      The mixture subsequent to the onset of grinding at an elevated temperature comprises titania nanosheets, partially cut titania nanotubes, and substantially uncut titania nanotubes. The grinding is effectuated for a sufficient amount of time to convert at least a portion of the nanoscroll material to nanosheets. Preferably, the grinding is effectuated using a ball mill. The drying process may include using nitrogen gas, an isopropanol dry, spin process technology, or increased temperature to drive off the water. It should be appreciated that the slurry may further include grinding media.

Importantly, the structure of the delaminated anatase-like titania nanosheet is different than the previously reported nanosheet structures, which were lepidocrocite-based layered titania (see, U.S. Pat. No. 6,838,160). Moreover, the method of synthesizing the delaminated anatase-like titania nanosheets described herein is much simpler and less time consuming than the prior art techniques, and can be mass produced in large quantities without special solvents or chemicals. The only limitation to how much nanosheet material may be produced using the process described herein is the size of the grinder, the amount of nanotube/nanoscroll reactant, and the extent of saturation of the top layer with titania nanosheet material. Prior to the surprising discovery of the inventors, titania precursor materials were typically deposited at elevated temperatures, such as in the range of 648° C. to 800° C. in order to ensure that the resultant titania film was crystalline, using techniques such as spray pyrolysis, magnetron sputtered vacuum deposition and chemical vapor deposition, which require large quantities of energy and are limited by how much product may be obtained.

In addition to having superior photoelectrochemical properties for applications such as solar cells, self-cleaning, H₂ sensing, decontamination, etc., the titania nanosheets described herein may be intercalated with lithium ions for use in battery applications or alternatively, decorated with dye molecules such as ruthenium complexes for use in solar cells. Specifically, the Li⁺, Na⁺ and/or dye molecules may be exchanged with the H⁺ ions on the nanosheet using processes known in the art.

The features and advantages are more fully illustrated by the following non-limiting examples, wherein all parts and percentages are by weight, unless otherwise expressly stated.

### Example 1

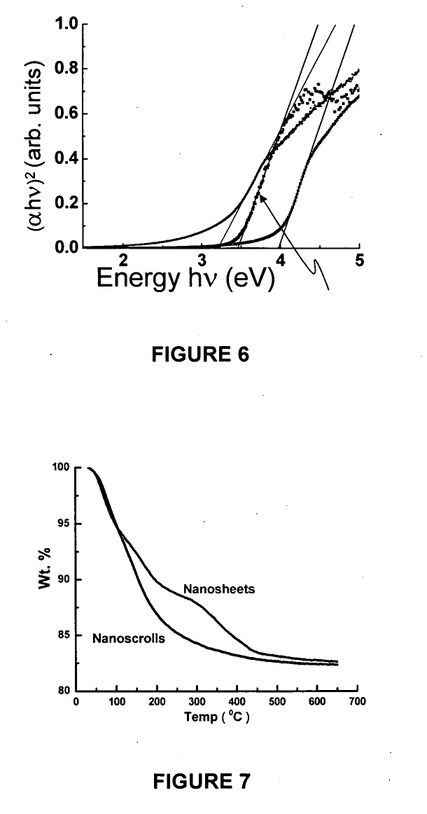

Nanotubes were synthesized from 32 nm anatase nanocrystals (Alfa Aesar, Ward Hill, Mass., USA) following the procedure described in Kleinhammes (Kleinhammes, A. et al., Chem. Phys. Lett. 411, 81-85 (2005)). 150 mg of synthesized nanotubes and 25 g of ZrO micro-beads were mixed together with 65 mL of distilled water in a Teflon grinding vessel. Grinding took place in a bead beater for 45 min at 100° C. At the conclusion of grinding, the ZrO beads sunk on the bottom and the top solution was transferred into centrifuge tubes using a pipette. The centrifuge tubes were sonicated for 15 min followed by centrifugation for 5 min at 4.4 k RPM. The top solution (least dense) contained the nanosheets. The top layer suspension was deposited on glass slides and dried at 50° C. TEM was performed on JEOL-100CX-II and HRTEM was done on JEOL-2010F (see, FIG. 4). UV-Vis was performed on Shimadzu ISR-3100 (see, FIGS. 6 and 7).

### Example 2

¹H nuclear magnetic resonance (NMR) under magic angle spinning (MAS) at spinning rate of 20 kHz is employed to evaluate the state of adsorbed water. FIG. 5 shows the ¹H NMR MAS spectra of nanosheets and nanotubes under various drying conditions. Two peaks are clearly resolved in as-synthesized nanosheet samples kept in a desiccator for 1 day, a broad low-field peak at 4.6 ppm and a narrow high-field peak at 1.2 ppm with LWHH of 1.1 ppm. The total number of protons measured is x=0.63 defined as TiO₂.xH₂O. Based on previous studies, the 1.2 ppm peak is associated with basic terminal hydroxyl Ti—OH and the broad peak at 4.6 ppm is typical of incorporated molecular water (Mastikhin, V. M., et al., Prog. NMR Spectrosc. 23, 259-299 (1991); Cracker, M. et al. J. Chem. Soc. Faraday Trans. 92, 2791-2798 (1996)). By drying the sample in the desiccator for 3 days, the 4.6 ppm peak is drastically reduced. The peak intensity of the 1.2 ppm peak is also reduced but at much smaller amount. Drying the nanosheet sample at 100° C. under N₂ gas flow for 12 hours almost completely removes the 4.6 ppm peak. The 1.2 ppm peak shifts to 1.0 ppm, indicating the terminal hydroxyl becomes more basic. It is also broadened slightly and its intensity is reduced further. The total proton content defined by x, peak shifts, and intensities are listed in Table 1.

TABLE 1
NMR determined water content x defined as
TiO₂ · xH₂O of nanosheets and nanotubes.

| Nano- | | | | | | Nano- | |
|---|---|---|---|---|---|---|---|
| sheets | x | H_{l-field} | H_{h-field} | δ_{l-field} | δ_{h-field} | tubes | x |
| 1 day | 0.63 | 0.63 | 0.63 | 4.8 ppm | 1.2 ppm | 1 day | 0.68 |
| 3 days | 0.33 | 0.16 | 0.50 | 5.0 ppm | 1.1 ppm | 3 days | 0.37 |
| 100° C. | 0.25 | 0.14 | 0.36 | 7.2 ppm | 1.0 ppm | | |

The low-field and high-field peak intensities observed in nanosheets, H_{l-field} and H_{h-field}, respectively, and the corresponding chemical shifts δ_{l-field} and δ_{h-field} are also listed.

¹H NMR MAS spectra of titania nanotubes are also shown in FIG. 5. It is very interesting to note that the well-defined peak at 1.2 ppm observed in nanosheets is completely missing in nanotubes, while the incorporated molecular water peak at 4.6 ppm is much stronger than that of nanosheets. There are two small peaks appearing at 2.1 ppm and 6.9 ppm, consistent with terminal hydroxyl and bridging hydroxyl groups observed in titania, respectively (Mastikhin, V. M., et al., Prog. NMR Spectrosc. 23, 259-299 (1991); Cracker, M. et al. J. Chem. Soc. Faraday Trans. 92, 2791-2798 (1996)). It is clear that water adsorption is less dissociative in nanotubes compared to nanosheets.

In conclusion, the NMR results suggest that nanotubes contain molecular water physically adsorbed onto the surface and hence, the nanotubes are a form of titania. In contrast, the NMR results suggest that nanosheets dissociate water and incorporate hydroxyl groups on the surface and hence, the nanosheets are a form of hydrated anatase or titanate.

Importantly, the theoretically predicted dissociative adsorption of water, which remains to be verified experimentally on the anatase (001) surface, is positively identified in this nanosheet material using ¹H NMR MAS spectra.

Accordingly, another aspect relates to novel titania nanosheet material, wherein the nanosheet material has ¹H NMR MAS spectra peaks positioned at (a) about 4.6 ppm and (b) about 1.2 ppm, after drying for 1 day.

Yet another aspect relates to an article of manufacture comprising a substrate and at least one layer of titania nanosheet material, wherein the nanosheet material has ¹H NMR MAS spectra peaks positioned at (a) about 4.6 ppm and (b) about 1.2 ppm after drying for 1 day. Substrates include quartz, glass, polymeric surfaces, and various metal surfaces.

Still another aspect relates to a method of manufacturing an article of manufacture, said method comprising:
depositing at least one titania nanosheet material on a substrate, wherein the nanosheet material has ¹H NMR MAS spectra peaks positioned at (a) about 4.6 ppm and (b) about 1.2 ppm, after drying for 1 day.
   Substrates include quartz, glass, polymeric surfaces, and various metal surfaces.

### Example 3

The major differences in the state of hydration between nanosheets and nanotubes also have a direct influence on their physical properties. FIG. 6 shows the UV-vis spectrum of anatase, nanotubes and nanosheets. Optical absorption is described by (αh v)ⁿ=A(hv−E_{g}) where α is the absorption coefficient, hv is the photo energy, and A is a constant. The value of n depends on whether the band gap is direct (n=2) or indirect (n=½). Data analysis shows that the UV-vis spectra of both nanotubes and nanosheets are described by n=2. FIG. 6 shows that the band gap E_{g} changes significantly from about 3.2 in anatase, to about 3.5 eV in nanotubes, and to about 4.0 eV in nanosheets.

Importantly, it can be seen that the band gap of the nanosheet material described herein is too large to absorb radiation in the visible range and as such, similar to other materials with large band gaps, dye molecules may be added to the materials to absorb visible radiation. Dye molecules contemplated include, but are not limited to, Ru(4,4′-dicarboxylic acid-2,2′-bipyridine)₂(NCS)₂ and Ru(II) dye called N719 from Solaronix® (Aubonne, Switzerland). Application of said dye may be achieved by immersing the nanosheet material in a composition including said dye, followed by drying.

Accordingly, another aspect relates to novel titania nanosheet material, wherein the nanosheet material has a band gap of about 4.0 eV.

Yet another aspect relates to an article of manufacture comprising a substrate and at least one layer of titania nanosheet material, wherein the nanosheet material has a band gap of about 4.0 eV. Substrates include quartz, glass, polymeric surfaces, and various metal surfaces. The titania nanosheet material may further include at least one dye molecule.

Still another aspect relates to a method of manufacturing an article of manufacture, said method comprising:
depositing at least one titania nanosheet material on a substrate, wherein the nanosheet material has a band gap of about 4.0 eV. Substrates include quartz, glass, polymeric surfaces, and various metal surfaces. The titania nanosheet material may further include at least one dye molecule.

### Example 4

Thermal gravimetric analysis (TGA) was performed to determine the weight loss of nanotubes and the nanosheet material described herein as a function of temperature. FIG. 7 further evidences the dissociation of water at the (001) surface of the delaminated anatase-like nanosheets described herein. It can be seen that the nanosheet TGA data includes a shoulder not seen in the nanotube TGA data, which evidences the presence of the stabilizing hydroxyl groups on the nanosheet material described herein.

Accordingly, while the invention has been described herein in reference to specific aspects, features and illustrative embodiments of the invention, it will be appreciated that the utility of the invention is not thus limited, but rather extends to and encompasses numerous other aspects, features and embodiments that result from the adsorption-induced tension in molecular (chemical and physical) bonds of adsorbed macromolecules and macromolecular assemblies. Accordingly, the claims hereafter set forth are intended to be correspondingly broadly construed, as including all such aspects, features and embodiments, within their spirit and scope.

1. A method of producing titania nanosheet material, said method comprising grinding a titania nanoparticle slurry under grinding conditions to produce a mixture comprising titania nanosheets, wherein the slurry includes titania nanoparticles and water.

2. The method of claim 1, wherein the titania nanoparticles comprise a material selected from the group consisting of nanotubes, nanoscrolls, nanofibers, nanorods, layered titanate, anatase, and combinations thereof.

3. The method of claim 1, wherein the titania nanoparticles comprise nanotubes or nanoscrolls.

4. The method of claim 1, wherein the mixture further comprises partially cut titania nanotubes, and substantially uncut titania nanotubes.

5. The method of claim 1, wherein the grinding conditions include a sufficient amount of time to convert at least a portion of the nanoparticle material to nanosheets.

6. The method of claim 1, wherein the grinding conditions include a neutral pH.

7. The method of claim 1, wherein the grinding conditions include temperature in a range from about 60° C. to about 200° C.

8. The method of claim 1, wherein the titania nanoparticle slurry further includes grinding media.

9. The method of claim 8, wherein the grinding media include hydrophobic materials.

10. The method of claim 8, wherein the grinding media comprise a material selected from the group consisting of zirconia, calcia-stabilized zirconia, magnesia-stabilized zirconia, yttria-stabilized zirconia, and combinations thereof.

11. The method of claim 1, wherein the titania nanosheet material comprises a property selected from the group consisting of:
(a) about a 4.0 eV band gap;
(b) a ¹H NMR MAS spectra peak at about 4.6 ppm for nanosheet samples desiccated for 1 day;
(c) a ¹H NMR MAS spectra peak at about 1.2 ppm for nanosheet samples desicatted for 1 day; and
(d) combinations thereof.

12. The method of claim 1, further comprising
separating a titania nanosheet suspension from the mixture.

13. The method of claim 12, wherein the separating includes centrifugation.

14. The method of claim 13, wherein the separating further includes sonication.

15. The method of claim 12, wherein the separating further includes sonication and centrifugation.

16. The method of claim 12, further including drying the titania nanosheet suspension to obtain titania nanosheets, wherein the drying is effectuated using a process selected from the group consisting of nitrogen gas, isopropanol dry, spin process technology, increased temperature to drive off the water, and combinations thereof.

17. (canceled)

18. The method of claim 16, further comprising grinding the titania nanosheets to produce a titania nanosheet powder.

19. A titania nanosheet, wherein the titania nanosheet material comprises a property selected from the group consisting of: (a) about a 4.0 eV band gap; (b) a ¹H NMR MAS spectra peak at about 4.6 ppm for nanosheet samples desiccated for 1 day; (c) a ¹H NMR MAS spectra peak at about 1.2 ppm for nanosheet samples desiccated for 1 day; and (d) combinations thereof.

20.-25. (canceled)

26. An article of manufacture comprising a substrate and at least one layer of titania nanosheet material, wherein the titania nanosheet material comprises a property selected from the group consisting of:
(a) about a 4.0 eV band gap;
(b) a ¹H NMR MAS spectra peak at about 4.6 ppm for nanosheet samples desiccated for 1 day;
(c) a ¹H NMR MAS spectra peak at about 1.2 ppm for nanosheet samples desiccated for 1 day; and
(d) combinations thereof.

27.-29. (canceled)
